(19) United States
(12) Patent Application Publication
(10) Pub. No.: US 2026/0030061 A1
(43) Pub. Date: Jan. 29, 2026

(54) DEPLOYING MACHINE LEARNING MODELS WITH AUTOMATED RESOURCE MANAGEMENT

(71) Applicant: eBay Inc., San Jose, CA (US)

(72) Inventors: Tianyu Chen, Suzhou (CN); Jingjing Jiang, Shanghai (CN); Xin Li, Huangpu District (CN); Maxim Manco, Cresskill, NJ (US); Vinay Phegade, Santa Clara, CA (US); Haowei Tian, Shanghai (CN); Yiheng Wang, Minhang (CN); Zhongyuan Wu, New District (CN); Guansheng Zhu, Minhang (CN)

(73) Assignee: eBay Inc., San Jose, CA (US)

(21) Appl. No.: 18/784,211

(22) Filed: Jul. 25, 2024

(51) Int. Cl. G06F 9/50; G06N 20/00

(52) U.S. Cl. CPC G06F 9/5027; G06N 20/00

(57) ABSTRACT

In the implementation of techniques for deploying machine learning models with automated resource management, a system receives logic corresponding to a machine learning model and computing resource data corresponding to a plurality of computing resources available. Based on the logic and the computing resource data, the system generates the machine learning model and an allocation of one or more computing resources of the plurality of computing resources available for the machine learning model, in which the machine learning model conforms to the logic. Upon generation of the machine learning model and the allocation of the one or more computing resources, the system deploys the machine learning model and the allocation of the one or more computing resources of the plurality of computing resources available for the machine learning model.

### BACKGROUND

Conventional techniques for allocating computing resources are often static, in which computing resources are allocated inflexibly, without considering the fluctuating computational needs of machine learning operations. Examples of this include allocating a fixed number of Central Processing Units (“CPUs”) or Graphics Processing Units (“GPUs”) to a machine learning task regardless of its real-time demand. However, such conventional techniques often lead to inefficient utilization of the computing resources, such as prolonged GPU idleness or CPU overloads.

Additionally, the conventional techniques for allocating the computing resources often provide inefficient workload distribution, assigning machine learning tasks to computing resources not best suited for them, resulting in computational inefficiencies and energy consumption. As such, the conventional techniques often result in suboptimal machine learning performance and constrain the scalability of machine learning operations.

### SUMMARY

Techniques and systems for deploying machine learning models with automated resource management are described. In an example, a computing device receives orchestration logic corresponding to a machine learning model and computing resource data corresponding to a plurality of computing resources available. Based on the orchestration logic and the computing resource data, the computing device generates the machine learning model and an allocation of one or more computing resources of the plurality of computing resources available for the machine learning model, in which the machine learning model conforms to the orchestration logic.

Upon generation of the machine learning model and the allocation of the one or more computing resources, the computing device deploys the machine learning model and the allocation of the one or more computing resources of the plurality of computing resources available for the machine learning model.

The disclosed techniques and systems enable efficient techniques for deploying machine learning models with automated resource management without inefficient utilization of one or more computing resources available for the machine learning models by leveraging orchestration logic and computing resource data corresponding to a plurality of computing resources available.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRA WINGS

The detailed description is described with reference to the accompanying figures. Entities represented in the figures are indicative of one or more entities and thus reference is made interchangeably to single or plural forms of the entities in the discussion.

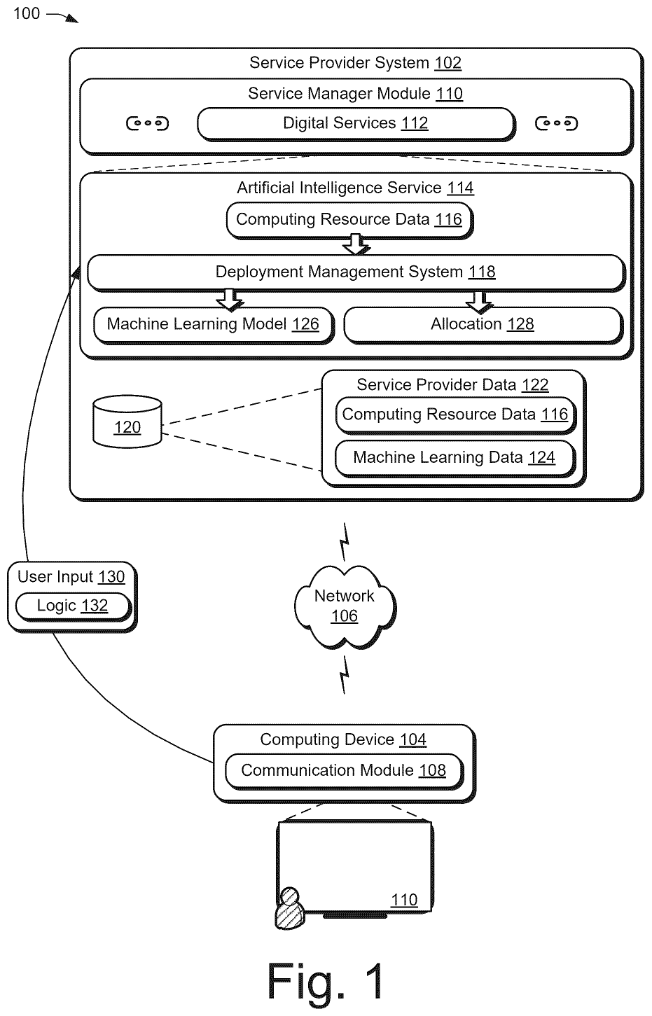

FIG. 1 is an illustration of a digital medium environment in an example implementation that is operable to employ techniques and systems for deploying machine learning models with automated resource management as described herein.

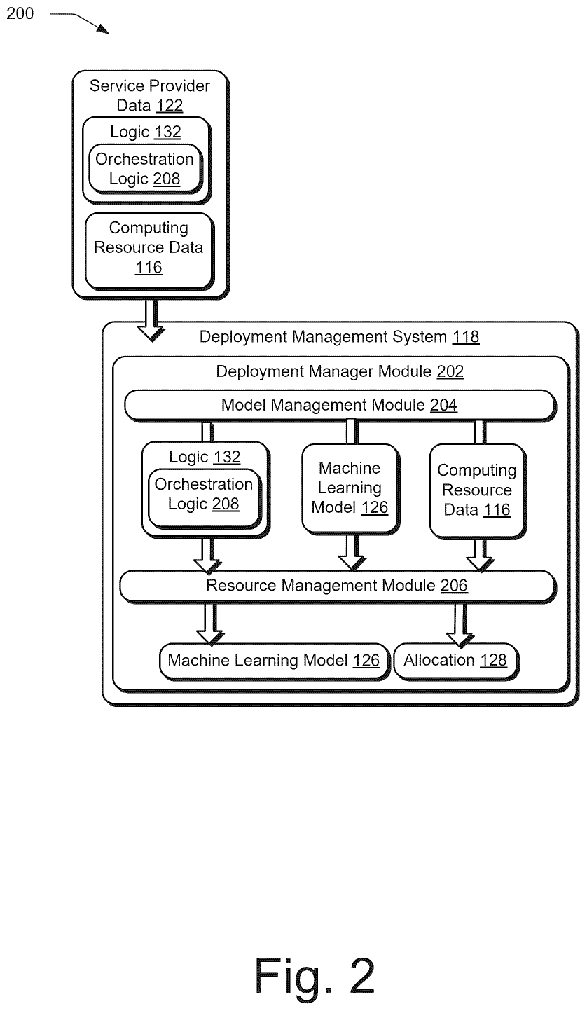

FIG. 2 depicts a system 200 in an example implementation showing operation of the deployment management system for generating and deploying the machine learning model and the allocation.

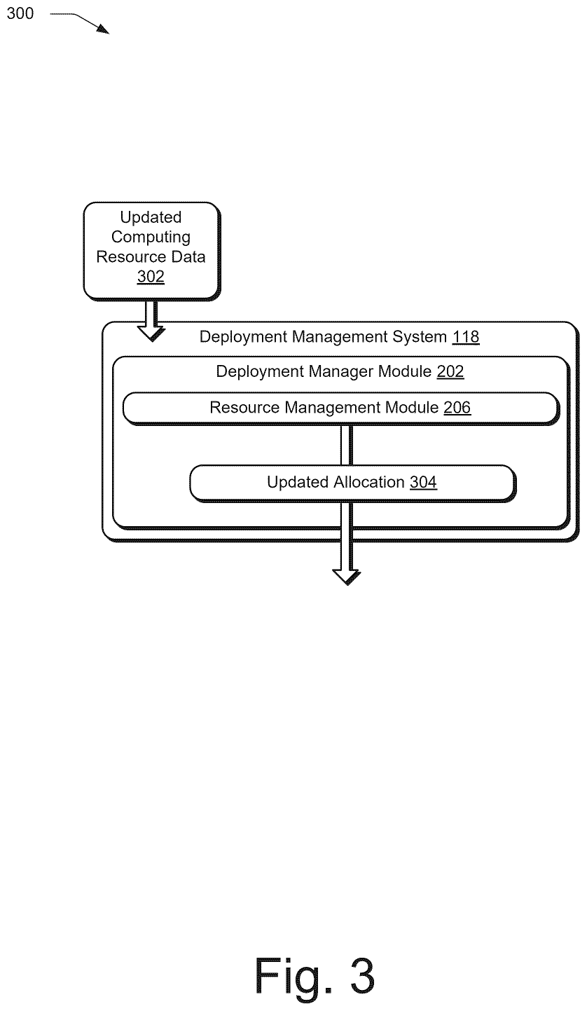

FIG. 3 depicts a system in an example implementation showing operation of the deployment management system for generating an updated allocation based on updated computing resource data.

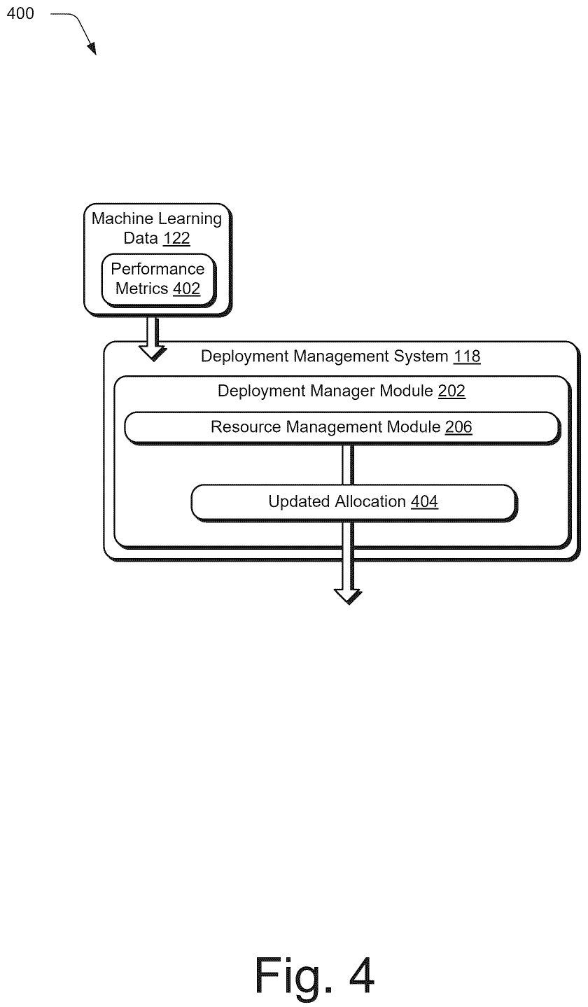

FIG. 4 depicts a system in an example implementation showing operation of the deployment management system for generating an updated allocation based on machine learning data.

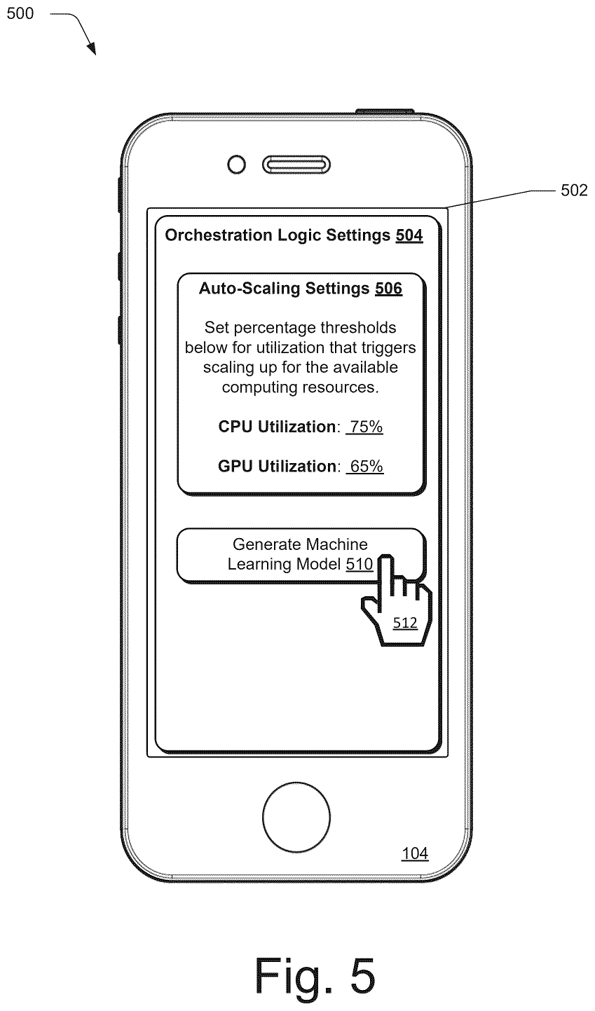

FIG. 5 depicts an example implementation of a user interface configured to receive orchestration logic via user input and to generate a machine learning model based on the orchestration logic.

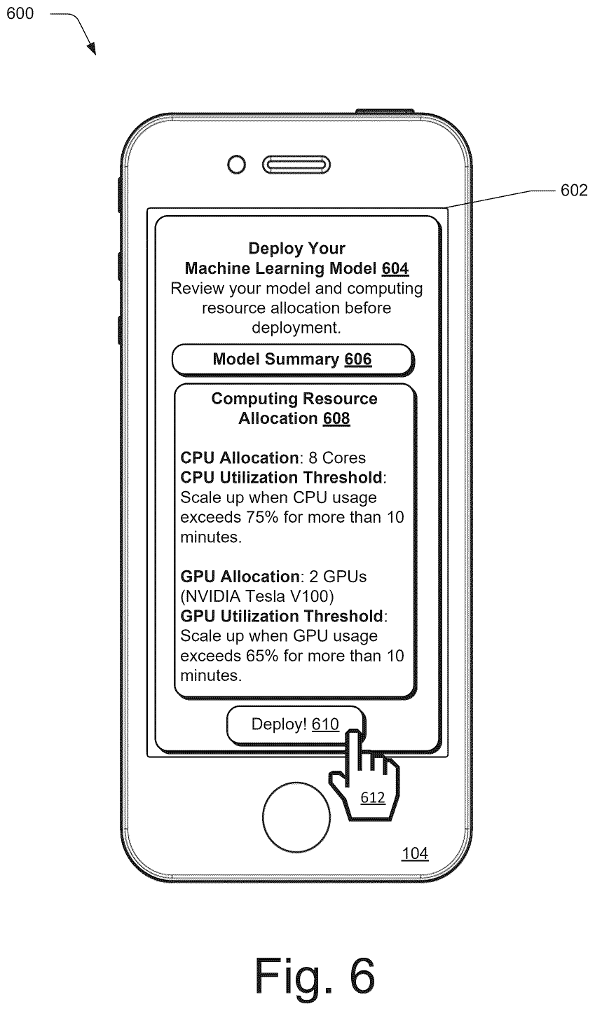

FIG. 6 depicts an example implementation of a user interface configured to deploy the machine learning model and an allocation of computing resources corresponding to the machine learning model.

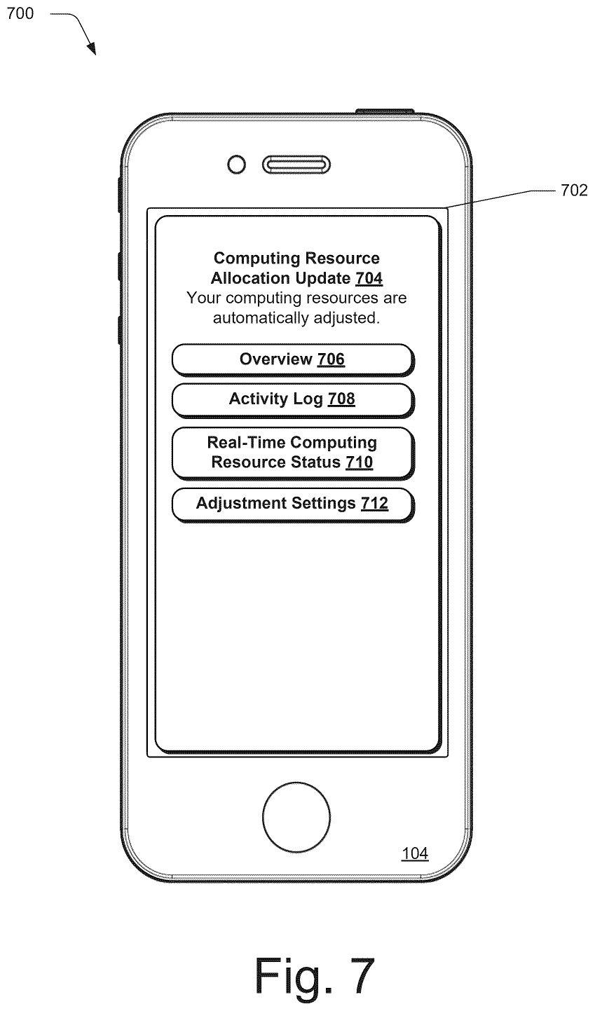

FIG. 7 depicts an example implementation of a user interface configured to automatically generate and deploy an updated allocation of computing resources for operation of the machine learning model.

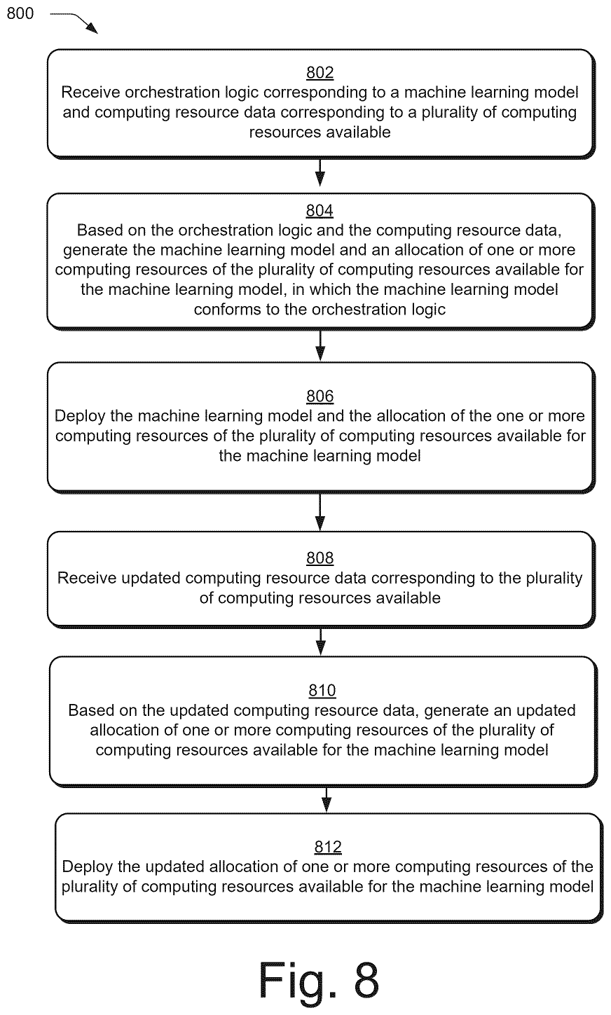

FIG. 8 depicts a procedure in an example implementation of deploying machine learning models with automated resource management.

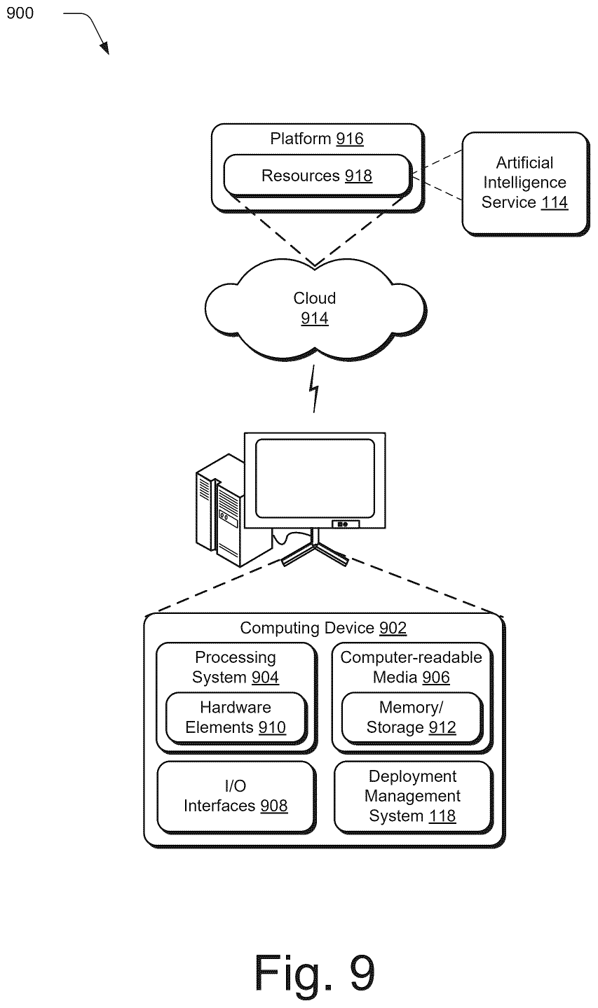

FIG. 9 illustrates an example system including various components of an example device that can be implemented as any type of computing device as described and/or utilized with reference to FIGS. 1-8 to implement examples of the techniques described herein.

### DETAILED DESCRIPTION

### Overview

Conventional techniques for allocating resources for machine learning models result in inefficiencies such as underutilized GPUs and overburdened CPUs, leading to suboptimal system performance and scalability constraints. These conventional techniques, which are characterized by static computing resource allocation, fail to adapt to the fluctuating computational needs inherent in machine learning operations.

Techniques for deploying machine learning models with automated resource management are described that overcome these limitations. For instance, consider an example in which a computing device, via a user interface, receives user input specifying orchestration logic for generating a machine learning model for real-time object detection in video surveillance. The user interface enables the user (e.g., via a user account) to specify various configurations affecting resource allocation (e.g., prioritizing GPU usage during high object activity) by using logic, such as the orchestration logic or convention logic.

Based on the user input, the computing device processes the orchestration logic in conjunction with real-time computing resource data on available computing resources, such as cloud-based GPUs and local server CPUs. The computing device then generates and deploys the machine learning model for object detection, initially deploying a resource allocation capable of dynamically adjusting in response to actual computational demands. As the machine learning model operates, the computing device monitors the machine learning model's performance (e.g., via performance metrics) and computing resource utilization, adjusting the allocation of computing resources (e.g., GPUs and CPUs) in real-time.

By way of example, if the machine learning model experiences increased load during peak surveillance hours, the computing device automatically reallocates computing resources to maintain optimal performance without overloading any single component.

By way of example, the computing device identifies that GPUs are over-provisioned during non-critical processing times based on the monitored computing resource utilization and the machine learning model's performance, and thus scales down the number of active GPUs and reallocates some computational tasks to CPUs, which are better suited for the current workload level. The updated allocation enables optimal processing power and computing resource utilization without wasting GPU resources.

This adaptive approach enables the deployment of the machine learning model with computing resource allocations that are continually optimized for actual conditions, thereby enhancing operational efficiency and machine learning model efficacy. Therefore, the described techniques for deploying machine learning models effectively automate dynamic management of computing resource utilization and resolve the computational inefficiency and energy consumption issues caused by the conventional techniques.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Environment

FIG. 1 is an illustration of a digital medium environment 100 in an example implementation that is operable to employ techniques and systems for deploying machine learning models with automated resource management.

The illustrated environment 100 includes a service provider system 102 and a client device 104 that are communicatively coupled, one to another, via a network 106. Computing devices that implement the service provider system 102 and the client device 104 are configurable in a variety of ways.

A computing device, for instance, is configurable as a desktop computer, a laptop computer, a mobile device (e.g., assuming a handheld configuration such as a tablet or mobile phone), and so forth. Thus, a computing device ranges from full resource devices with substantial memory and processor resources (e.g., personal computers, game consoles) to a low-resource device with limited memory and/or processing resources (e.g., mobile devices). Additionally, although a single computing device is described in some examples, a computing device is also representative of a plurality of different devices, such as multiple servers utilized by a business to perform operations “over the cloud” as described in FIG. 9.

The client device 104 includes a communication module 108 that is representative of functionality to communicate via the network 106 with a service manager module 110 of the service provider system 102. The service manager module 110 is configured to implement digital services 112. Digital services 112 are usable to expose a variety of functionality to the client device 104, an example of which is illustrated as an artificial intelligence service 114. The artificial intelligence service 114 is configured to manage artificial intelligence content based on received inputs. The artificial intelligence service 114, for instance, is configurable to generate and deploy artificial intelligence models, to manage allocation of computing resources pertaining to the artificial intelligence models generated, and so forth.

In the illustrated example, the artificial intelligence service 114 employs computing resource data 116. The computing resource data 116 includes data pertaining to computing resources available for models (e.g., machine learning models) of the artificial intelligence service 114. Examples of the computing resource data include specification data, utilization data, performance and efficiency metrics, availability data, and cost data for computing resources available for the artificial intelligence service 114.

The computing resources include hardware computing resources, software computing resources, and virtual computing resources for performing computational tasks. Examples of hardware computing resources include Central Processing Units (“CPUs”), Graphics Processing Units (“GPUs”), Tensor Processing Units (“TPUs”), Random Access Memory (“RAM”), Application-Specific Integrated Circuits (“ASICs”), Hard Disk Drives (“HDDs”), and Solid State Drives (“SSDs”). Examples of software computing resources include operating systems (e.g., for managing the hardware computing resources) and application software. Examples of virtual computing resources include Virtual Machines (“VMs”), containers, and cloud computing resources such as Amazon Web Services (“AWS”), Microsoft Azure, and so forth. In some embodiments, the computing resources include cloud computing resources and local computing resources, such as edge computing resources.

The specification data includes specifics about each computing resource available, such as a type of the computing resource (e.g., GPU, CPU, TPU, etc.), availability, performance metrics, location (e.g., AWS EC2, a local server, etc.), and cost metrics. The utilization data indicates a current utilization for each computing resource, such as a current load, in-progress tasks, historical usage patterns, and failover states. The performance and efficiency metrics include data providing insights into how effectively each computing resource is being utilized, such as throughput, latency, error rates, and energy efficiency. The availability data includes data reflecting changes in the computing resource availability, such as computing resource additions and computing resource removals. The cost data includes price updates for using the computing resources.

The artificial intelligence service 114 includes a deployment management system 118 that is configured for managing deployment for models (e.g., machine learning models) and computing resources available for the machine learning models 126. The deployment management system 118, in some instances, generates machine learning models 126. Examples of the generating of the machine learning model 126 include training the machine learning model 126, configuring a pre-trained machine learning model for the machine learning model 126, and selecting a pre-existing machine learning model for the machine learning model 126. The deployment management system 118 utilizes computing resource data 116 and machine learning data 124 to configure machine learning and computing resource deployments.

The deployment management system 118 generates and manages a machine learning model 126 tailored to specific services or tasks required (e.g., based on convention logic, orchestration logic, etc.), ensuring that the machine learning model 126 meets the requirements of users and system capabilities. The deployment management system 118 dynamically allocates computing resources (e.g., CPUs, GPUs, etc.) to each model through an allocation 128 generated by the deployment management system 118. Each allocation 128 is sensitive to each machine learning model's 126 computational demands, the availability of computing resources (e.g., as indicated by the computing resource data 116), and in some instances, cost-effectiveness, to achieve greater computational efficiency and performance.

The machine learning model 126 represents the one or more artificial intelligence models generated and deployed by the deployment management system 118. The machine learning models 126 are configured to perform a variety of tasks, such as complex predictive analytics, based on the inputs and configurations processed by the deployment management system 118. The effectiveness and efficiency of the machine learning models 126 are, in some instances, continuously monitored and improved upon by utilizing real-time performance metrics and historical data of the machine learning data 124.

The storage device 120 of the service provider system 102 includes service provider data 122 containing data pertaining to the offerings (e.g., the digital services 112) and operations of the service provider system 102. The service provider data 122 includes the computing resource data 116 pertaining to the computing resources available and the machine learning data 124 pertaining to the machine learning operations of the deployment management system 118.

In some instances, the machine learning data 124 includes data supporting the training, configuration, and optimization of the machine learning model 126. Examples of the machine learning data 124 include training data, parameters for model behavior, performance metrics, and historical operational data.

User input 130 and logic 132 are provided to the service provider system 102 and the artificial intelligence service 114 via the communication module 108 of the client device 104. The user input 130 includes specifications, commands, or queries provided by users. Examples of the logic 132 include orchestration logic, convention logic, and so forth. In the context of generating the machine learning model 126, the logic 132 serves as a framework for rules, guidelines, or processes that the deployment management system 118 utilizes to effectively manage and deploy computing resources and models, and to construct or adjust machine learning models 126 accordingly. Examples of the logic 132 encompass various forms, including operational logic such as convention logic and orchestration logic.

Convention logic includes predefined standards, norms, or procedures that the deployment management system 118 adheres to when generating and refining the machine learning models 126. Examples of convention logic include data preprocessing guidelines, model architecture standards, hyperparameter tuning protocols, evaluation metrics for assessing performance of the machine learning model, and so forth. The convention logic ensures consistency and reproducibility in machine learning model training and generation processes.

Orchestration logic defines the orchestration of the machine learning model 126. Examples of orchestration logic include one or more steps in the training process for the machine learning model 126, distribution of training tasks across computational resources, selection of a deployment environment for the machine learning model 126, and so forth. Orchestration logic in the context of machine learning include predefined rules, procedures, or configurations that automate management and coordination of computing resources and tasks for generating and deploying machine learning models 126.

In some examples, the orchestration logic is configured to monitor performance metrics of the machine learning model 126 and the computing resources to ensure efficient operation (e.g., ensuring that performance metrics of the machine learning model 126 exceed a threshold amount) of the machine learning model 126 and the computing resources. In some embodiments, the orchestration logic includes computing resource allocation logic, such as rules for assigning specific types of computing resources to different stages of a machine learning pipeline for the machine learning model 126. For instance, the computing resource allocation logic assigns GPUs for training the machine learning model 126 (e.g., due to GPUs' performance for parallelizable tasks), whereas the computing resource allocation logic assigns CPUs for data preprocessing and less intensive computations of the machine learning model 126.

The orchestration logic, in some instances, includes workflow management logic, in which the workflow management logic defines a sequence and conditions under which different tasks are executed for the machine learning model 126. In some examples, the workflow management logic defines dependencies between tasks for the machine learning model 126, such as not starting training of the machine learning model 126 until data preprocessing is complete.

In some embodiments, the orchestration logic includes scaling logic, in which the scaling logic specifies rules for when and how to scale computing resources up or down based on workload demands for the machine learning model 126, such as in cloud environments in which computing resources can be easily adjusted dynamically.

In some instances, the logic 132 component includes predefined or user-specified algorithms or processing rules that specify how inputs are interpreted and acted upon. The logic 132 ensures that user requests for the machine learning models 126 are efficiently and effectively met with appropriate allocations 128 and model configurations.

The allocation 128, which is managed and deployed by the deployment management system 118, plays a key role in assigning the appropriate computing resources to each machine learning model 126 based the machine learning model 126's needs. The allocation 128 not only ensures that each machine learning model 126 operates efficiently but also manages efficient utilization of the computing resources.

The components of the service provider system 102 and the computing device 104 create a robust framework for deploying and managing the artificial intelligence services 114. The components allow for the dynamic and efficient use of computing resources, optimize the performance of machine learning operations, and ensure that the deployment management system 118 adapts effectively to meet evolving computational demands and external conditions for the machine learning models 126. Further discussion of these and other examples is included in the following sections and shown in corresponding figures.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Deploying Models With Automated Resource Management

The following discussion describes techniques that are implementable utilizing the previously described systems and devices. Aspects of each of the procedures are implemented in hardware, firmware, software, or a combination thereof. The procedures are shown as a set of blocks that specify operations performed and/or caused by one or more devices and are not necessarily limited to the orders shown for performing the operations by the respective blocks.

FIG. 2 depicts a system 200 in an example implementation showing operation of deployment management system 118 of FIG. 1 in greater detail as receiving the logic 132 and the computing resource data 116, generating and deploying the machine learning model 126 and the allocation 128. The deployment management system 118 implemented in this example includes a deployment manager module 202 including a model management module 204 and a resource management module 206.

The deployment management system 118 is illustrated as receiving the service provider data 122, in which the service provider data 122 includes the logic 132 and the computing resource data 116 of FIG. 1. The logic 132 is configurable in a variety of ways, an example of which is illustrated as orchestration logic 208.

As discussed throughout, the orchestration logic 208 defines orchestration of the machine learning model 126. Examples of orchestration logic 208 include one or more steps in the training process for the machine learning model, distribution of training tasks across computational resources, selection of a deployment environment for the machine learning model, and so forth. In some embodiments, the orchestration logic 208 is configurable to streamline techniques involving a plurality of computing tasks and computing resource types. In some examples, the orchestration logic 208 is configured to manage a sequence of operations for training, validating, and deploying machine learning models. The orchestration logic 208, for instance, is configured to determine how computing resources (e.g., CPUs, GPUs, etc.) are allocated based on a configuration of the machine learning model.

In some examples, the orchestration logic 208 includes performance optimization logic, in which the performance optimization logic includes algorithms or heuristics configured to optimize performance of machine learning processes of the machine learning model 126 (e.g., training, inference, etc.). For instance, the performance optimization logic is configurable to generate or modify hyperparameters or an architecture for the machine learning model 126.

The orchestration logic 208, in some instances, includes failover and recovery logic, in which the failover and recovery logic specifies procedures for handling failures for the machine learning model 126 and ensuring a threshold amount of availability for the plurality of computing resources. In some examples, the failover and recovery logic configures the machine learning model 126 to automatically restart one or more failed tasks for the machine learning model 126.

In some embodiments, the orchestration logic 208 includes cost management rules for keeping costs of the computing resources used by the machine learning model 126 below a threshold cost while still meeting performance targets. In some cases, the cost management rules specify utilizing preemptible servers for training tasks, such as during off-peak hours to lower costs of the computing resources used by the machine learning model 126 to below the threshold cost.

In some examples, the logic 132 includes the convention logic. Examples of the convention logic include threshold logic, auto-scaling logic, operational logic, load balancing logic, redundancy logic, data privacy logic, audit logic, cost optimization logic, energy consumption logic, real-time model adjustment logic, deployment scheduling logic, maintenance scheduling logic, and so forth.

In some embodiments, the deployment management system 118 is configured to receive the orchestration logic 208 from the communication module 108 from a computing device 104, an example of which is via orchestration logic 208 provided via the user input 130 provided via a user interface of the computing device 104. The logic or the orchestration logic 208, for instance, is receivable as part of a request for generating the machine learning model 126.

The deployment manager module 202 of the deployment management system 118 is configured to manage the machine learning models 126 and the allocations 128 corresponding to the machine learning models 126, such as the generation of the machine learning models 126. The deployment manager module 202 of the deployment management system 118 is configurable in a variety of ways, including receiving the service provider data 122, the logic 132, the machine learning data 124, and the computing resource data 116, for instance, from the service provider system 102, the computing device 104, the deployment management system 118, and so forth. The deployment manager module 202, as illustrated, passes the service provider data 122 including the logic 132 (including the orchestration logic 208) and the computing resource data 116 to the model management module 204 of the deployment manager module 202.

To continue this illustrated example system 200, the model management module 204 is configurable to generate machine learning models 126 in a variety of ways, including based on the various logic 132 received, such as convention logic or the orchestration logic 208, and the computing resource data 116. In some examples, the model management module 204 generates the machine learning model 126 based one or more of the logic 132, the orchestration logic 208, or the computing resource data 116. In this illustrated example, the model management module is illustrated as generating the machine learning model 126 based on the logic 132 including the orchestration logic 208, and the computing resource data 116. The model management module 204 is configured to pass a variety of data to the resource management module 206 or other modules of the deployment manager module 202, such as the service provider data 122, the logic 132, the orchestration logic 208, the computing resource data 116, and the machine learning model 126. The model management module 204, as illustrated, passes the logic 132 (including the orchestration logic 208), the machine learning model 126, and the computing resource data 116 to the resource management module 206.

In general, the resource management module 206 of the deployment manager module 202 is configured to manage the computing resources available for computational operations of the deployment management system 118, such as for the machine learning model 126. The resource management module 206 is configurable in a variety of ways, an example of which is illustrated as generating the allocation 128 of one or more computing resources of a plurality of computing resources available for the machine learning operations of the deployment management system 118, for the machine learning operations of the machine learning model 126.

The resource management module 206 is illustrated as receiving the computing resource data 116, the machine learning model 126, and the logic 132 (including the orchestration logic 208), however, the resource management module 206 is configured to receive a variety of data, such as data of the service provider data 122. The resource management module 206, as illustrated, generates the allocation 128 for the machine learning model 126 based on machine learning model 126, the logic 132 (including the orchestration logic 208), and the computing resource data. The resource management module 206 passes the generated machine learning model 126 and the generated allocation 128 to the deployment manager module 202.

In some embodiments, the deployment manager module 202 monitors data pertaining to the machine learning model 126, such as performance metrics pertaining to the machine learning model 126, and updated computing resource data, which is described in FIG. 3. In some examples, the monitoring of the data is in real-time. Based on the updated data, the deployment manager module 202 is configured to generate an updated resource allocation automatically and without human intervention. In the context of the deployment management system 118, consider the following discussion of FIG. 3.

FIG. 3 depicts a system 300 in an example implementation showing operation of the deployment management system 118 of FIGS. 1 and 2, in which the deployment management system 118 receives updated computing resource data 302. As already noted, the illustrated system 300 includes the deployment management system 118 of FIG. 1, in which the deployment management system 118 includes the deployment manager module 202 including the resource management module 206 of FIG. 2.

To begin this example of the system 300, the deployment management system 118 and receives the updated computing resource data 302. The updated computing resource data 302, in general, includes recent data pertaining to the computing resources available for machine learning operations for the deployment management system 118, or in some instances, the service provider system 102. In some examples, the updated computing resource data 302 includes metrics and indicators that reflect changes in the computing resources, such as data pertaining to resource utilization levels, availability of the computing resources, operational status, cost information, and performance metrics of the computing resources.

Examples of resource utilization data of the updated computing resource data 302 include a percentage of CPU capacity being used (e.g., 70% utilization) or a percentage of GPU capacity being used. Examples of performance metrics include latency metrics or throughput metrics.

The deployment management system 118 passes the updated computing resource data 302 to the resource management module 206. As illustrated, the resource management module 206 generates and deploys the updated allocation 304 of computing resources for the machine learning model 126 based on the updated computing resource data. In some instances, the resource management module 206 generates the updated allocation 304 based on other types of data, such as the machine learning data 124, as depicted in FIG. 4. In some examples, the resource management module 206 generates the updated allocation 304 based on the updated computing resource data 302 indicating a utilization amount of the one or more computing resources for the machine learning model 126 exceeding or not exceeding a threshold utilization amount. In some embodiments, the updated allocation 304 of the one or more computing resources of the plurality of computing resources available for the machine learning model 126 is adapted to the updated computing resource data 302 of the plurality of computing resources to increase efficiency of utilization of the plurality of computing resources available by the machine learning model 126. In the context of the deployment management system 118, consider the following discussion of FIG. 4.

FIG. 4 depicts a system 400 in an example implementation showing operation of the deployment management system 118 of FIGS. 1 and 2, in which the deployment management system 118 receives machine learning data 124. As already noted, the illustrated system 400 includes the deployment management system 118 of FIG. 1, in which the deployment management system 118 includes the deployment manager module 202 including the resource management module 206 of FIG. 2.

To begin this example of the system 400, the deployment management system 118 and receives the machine learning data 124 including performance metrics 402 pertaining to performance of the machine learning model 126. In general, the performance metrics 402 include quantitative measures for evaluating the performance (e.g., the efficiency, effectiveness, accuracy, and so forth) of the machine learning model 126. Some examples of the performance metrics 402 include inference latency, model convergence time, model robustness, feature importance, resource efficiency, accuracy, precision and recall, F1 score, AUC-ROC curve, and so forth. Examples of resource efficiency data of the performance metrics 402 include energy consumption per inference, a memory footprint during operations for the machine learning model 126, utilization quantities for each of the computing resources from the allocation 128, and so forth.

The deployment management system 118 passes the performance metrics 402 to the resource management module 206. As illustrated, the resource management module 206 generates and deploys the updated allocation 404 of computing resources for the machine learning model 126 based on the performance metrics 402. In some instances, the resource management module 206 generates the updated allocation 304, additionally, or alternatively, based on other types of data, such as the updated computing resource data 302, as depicted in FIG. 3.

In some examples, the resource management module 206 generates the updated allocation 404 based on the machine learning data 124 (e.g., the performance metrics 402) indicating one or more metrics corresponding to the machine learning model 126 exceeding or not exceeding a threshold amount. In some examples, the resource management module 206 generates the updated allocation 304 to increase performance (e.g., via the performance metrics 402) of the machine learning model 126. In the context of the deployment management system 118, consider the following discussion of FIG. 5.

FIG. 5 depicts an example implementation 500 of a user interface 502 configured to receive orchestration logic 506 via user input 512. The user interface 502, as illustrated for the computing device 104, includes orchestration logic settings 504 including orchestration logic 506 input via user input 512. In this example implementation 500, the orchestration logic 506 pertains to auto-scaling settings for setting percentage thresholds below utilization that triggers scaling up for the available computing resources. The orchestration logic 506 specifically describes threshold percentages specified by the user input 512, in which the threshold for CPU utilization is set as 75% and the GPU utilization is set as 65%.

The orchestration logic 506 is presentable via a variety of formats, such as via text, via a slider bar, and so forth. The user interface 502 also includes a selectable visual element 510, in which the visual element is selectable via the user input 512 to generate the machine learning model 126 based on the orchestration logic 506. In some examples, the communication module 108 of the computing device 104 receives the user input 512 and passes the selections to other modules, such as the model management module 204.

The user interface 502 and the communication module 108 are configured to recognize various types of the user input 512, including but not limited to typing text into fields (e.g., threshold percentages of the orchestration logic 506), selecting options from dropdown menus, clicking or tapping on buttons or links, toggling switches, dragging and dropping objects, providing voice commands, and uploading files. In the context of deploying the machine learning model 126 and an allocation corresponding to the machine learning model 126, consider the following discussion of FIG. 6.

FIG. 6 depicts an example implementation 600 of a user interface 602 configured to deploy the machine learning model 126 and an allocation 608 of computing resources corresponding to the machine learning model 126 operations via user input 612. The user interface 602, as illustrated for the computing device 104, includes a description 604 for deploying the machine learning model 126, a model summary 606 summarizing the generated machine learning model 126, a computing resource allocation 608 generated based at least in part on the orchestration logic 506, and a visual element 610 selectable via user input 612 for deploying the machine learning model 126 and the allocation 608.

In this example implementation 600, the allocation 608 includes a CPU allocation of eight cores, in which the CPU utilization threshold is to scale up when CPU utilization exceeds 75% for more than ten minutes, and a GPU allocation of two NVIDIA Tesla V100 GPUs, in which the GPU utilization threshold is to scale up when GPU usage exceeds 65% for more than ten minutes.

pertains to auto-scaling settings for setting percentage thresholds below utilization that triggers scaling up for the available computing resources. The orchestration logic 506 specifically describes threshold percentages specified by the user input 512, in which the threshold for CPU utilization is set as 75% and the GPU utilization is set as 65%. The user interface 502 also includes a selectable visual element 510, in which the visual element is selectable via the user input 512 to generate the machine learning model 126 based on the orchestration logic 506. In some examples, the communication module 108 of the computing device 104 receives the user input 512 and passes the selections to other modules, such as the model management module 204. In the context of generating and deploying an updated allocation of computing resources, consider the following discussion of FIG. 7.

FIG. 7 depicts an example implementation 700 of a user interface 702 configured to generate and deploy an updated allocation of computing resources. As illustrated, the computing resources are adjusted automatically based real-time data, such as the updated computing resource data 302 of FIG. 3 or the performance metrics 402 of FIG. 4. The user interface 702, as illustrated for the computing device 104, includes a description 704 for an updated allocation of computing resources for the machine learning model 126. The user interface 702 for updated allocations is configurable to display information or representations of information pertaining to the updated allocation. The user interface 702, as depicted, includes visual elements 706, 708, 710, and 712, which are selectable for additional information pertaining to the updated allocation.

Specifically, visual element 706 pertains to an overview of the updated allocation, visual element 708 pertains to an activity log for the plurality of computing resources available, visual element 710 pertains to a real-time status for each of the plurality of computing resources available, and visual element 712 pertains to adjustment settings configurable to adjust the updated allocation of the computing resources. In the context of deploying machine learning models with automated resource management, consider next the following discussion of FIG. 8.

### Example Procedures

The following discussion describes techniques which are implementable utilizing the previously described systems and devices. Aspects of each of the procedures are implementable in hardware, firmware, software, or a combination thereof. The procedures are shown as a set of blocks that specify operations performed by one or more devices and are not necessarily limited to the orders shown for performing the operations by the respective blocks. In portions of the following discussion, reference is made to FIGS. 1-8.

FIG. 8 depicts a procedure 800 in an example implementation of deploying machine learning models with automated resource management. At block 802, orchestration logic 208 corresponding to a machine learning model 126 and computing resource data 116 corresponding to a plurality of computing resources available is received. In some examples, the deployment management system 118 receives the orchestration logic 208 and computing resource data 116 from the communication module 108 of the computing device 104, as part of a request for generating the machine learning model 126. As discussed throughout, examples of the orchestration logic 208 include a variety of configurable aspects such as performance optimization logic, failover and recovery logic, and cost management rules designed to maintain computing resource costs below a certain threshold while meeting performance targets.

At block 804, based on the orchestration logic 208 and the computing resource data 116, the machine learning model 126 and an allocation 128 of one or more computing resources of the plurality of computing resources available for the machine learning model 126 is generated, in which the machine learning model 126 conforms to the orchestration logic 208. In some embodiments, the model management module 204 of the deployment manager module 202 generates the machine learning model 126 based on provided logic 132 and computing resource data 116, and the resource management module 206 of the deployment manager module 202 formulates an allocation plan via the allocation 128, which specifies instructions for computing resource utilization based on the specific requirements of the machine learning model 126.

At block 806, the machine learning model 126 and the allocation 128 of the one or more computing resources of the plurality of computing resources available for the machine learning model 126 are deployed. In some examples, the deployment management module 202 is configured to deploy both the machine learning model 126 and its allocation 128 of one or more computing resources.

At block 808, updated computing resource data 302 corresponding to the plurality of computing resources available is received. By way of example, the deployment manager module 202 is configured to receive the updated computing resource data 302 corresponding to the plurality of computing resources available for the deployment management system 118. In some embodiments, the user interface 702 is configured to display the activity log (e.g., as depicted by visual element 708 of user interface 702) corresponding to the updated computing resource data 302.

At block 810, based on the updated computing resource data 302, an updated allocation 304 of one or more computing resources of the plurality of computing resources available for the machine learning model 126 are generated. By way of example, the resource management module 206 generates the updated allocation 304 (e.g., by adjusting the allocation 128) responsive to changes identified in the updated computing resource data 302. In some embodiments, the resource management module 206 generates the updated allocation 304 based on one or more metrics of the computing resource data 302 exceeding or not exceeding a threshold amount. In some examples, the threshold amount is predefined, such as by the user input 130 received via the communication module 108.

At block 812, the updated allocation 304 of one or more computing resources of the plurality of computing resources available for the machine learning model 126 is deployed. In some embodiments, the deployment manager module 202 deploys the updated allocation 304 automatically and without human intervention such as based on predefined rules set within the orchestration logic 208.

In the context of an example system and device for deploying machine learning models with automated resource management, consider the following discussion of FIG. 9.

### Example System and Device

FIG. 9 illustrates an example system generally at 900 that includes an example computing device 902 that is representative of one or more computing systems and/or devices that implement the various techniques described herein. This is illustrated through inclusion of the deployment management system 118 and the artificial intelligence service 114. The computing device 902 is configurable, for example, as a server of a service provider, a device associated with a client (e.g., a client device), an on-chip system, and/or any other suitable computing device or computing system.

The example computing device 902 as illustrated includes a processing system 904, one or more computer-readable media 906, and one or more I/O interface 908 that are communicatively coupled, one to another. Although not shown, the computing device 902 further includes a system bus or other data and command transfer system that couples the various components, one to another. A system bus includes any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 904 is representative of functionality to perform one or more operations using hardware. Accordingly, the processing system 904 is illustrated as including hardware element 910 that is configurable as processors, functional blocks, and so forth. This includes implementation in hardware as an application specific integrated circuit or other logic device formed using one or more semiconductors. The hardware elements 910 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 906 is illustrated as including memory/storage 912. The memory/storage 912 represents memory/storage capacity associated with one or more computer-readable media. The memory/storage 912 includes volatile media (such as random access memory (RAM)) and/or nonvolatile media (such as read only memory (ROM), Flash memory, optical disks, magnetic disks, and so forth). The memory/storage 912 includes fixed media (e.g., RAM, ROM, a fixed hard drive, and so on) as well as removable media (e.g., Flash memory, a removable hard drive, an optical disc, and so forth). The computer-readable media 906 is configurable in a variety of other ways as further described below.

Input/output interface(s) 908 are representative of functionality to allow a user to enter commands and information to computing device 902, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 902 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 902. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 902, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 910 and computer-readable media 906 are representative of modules, programmable device logic and/or fixed device logic implemented in a hardware form that are employed in some examples to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 910. The computing device 902 is configured to implement particular instructions and/or functions corresponding to the software and/or hardware modules. Accordingly, implementation of a module that is executable by the computing device 902 as software is achieved at least partially in hardware, e.g., through use of computer-readable storage media and/or hardware elements 910 of the processing system 904. The instructions and/or functions are executable/operable by one or more articles of manufacture (for example, one or more computing devices and/or processing systems 904) to implement techniques, modules, and examples described herein.

The techniques described herein are supported by various configurations of the computing device 902 and are not limited to the specific examples of the techniques described herein. This functionality is also implementable through use of a distributed system, such as over a “cloud” 914 via a platform 916 as described below.

The cloud 914 includes and/or is representative of a platform 916 for resources 918. The platform 916 abstracts underlying functionality of hardware (e.g., servers) and software resources of the cloud 914. The resources 918 include applications and/or data that can be utilized while computer processing is executed on servers that are remote from the computing device 902. Resources 918 can also include services provided over the Internet and/or through a subscriber network, such as a cellular or Wi-Fi network.

The platform 916 abstracts resources and functions to connect the computing device 902 with other computing devices. The platform 916 also serves to abstract scaling of resources to provide a corresponding level of scale to encountered demand for the resources 918 that are implemented via the platform 916. Accordingly, in an interconnected device example, implementation of functionality described herein is distributable throughout the system 900. For example, the functionality is implementable in part on the computing device 902 as well as via the platform 916 that abstracts the functionality of the cloud 914.

What is claimed is:

1. A method comprising:
receiving orchestration logic corresponding to a machine learning model and computing resource data corresponding to a plurality of computing resources available;
based on the orchestration logic and the computing resource data, generating the machine learning model and an allocation of one or more computing resources of the plurality of computing resources available for the machine learning model, in which the machine learning model conforms to the orchestration logic; and
deploying the machine learning model and the allocation of the one or more computing resources of the plurality of computing resources available for the machine learning model.

2. The method of claim 1, wherein the orchestration logic includes one or more of computing resource allocation logic, workflow management logic, scaling logic, performance optimization logic, failover and recovery logic, or cost management logic.

3. The method of claim 1, further comprising receiving convention logic pertaining to the machine learning model, and wherein the generating of the machine learning model and the allocation of the one or more computing resources of the plurality of computing resources available is based in part on the convention logic pertaining to the machine learning model.

4. The method of claim 1, wherein the plurality of computing resources available includes one or more of Graphics Processing Units (“GPUs”), Central Processing Units (“CPUs”), or Tensor Processing Units (“TPUs”).

5. The method of claim 1, wherein the plurality of computing resources available includes one or more of cloud computing resources and local computing resources.

6. The method of claim 1, further comprising:
receiving updated computing resource data corresponding to the plurality of computing resources available;
based on the updated computing resource data, generating an updated allocation of one or more computing resources of the plurality of computing resources available for the machine learning model; and
deploying the updated allocation of one or more computing resources of the plurality of computing resources available for the machine learning model.

7. The method of claim 6, wherein the generating of the updated allocation is based on the updated computing resource data indicating a utilization amount of the one or more computing resources not exceeding a threshold utilization amount.

8. The method of claim 6, wherein the updated allocation of one or more computing resources of the plurality of computing resources available for the machine learning model is adapted to the updated computing resource data of the plurality of computing resources to increase efficiency of utilization of the plurality of computing resources available by the machine learning model.

9. The method of claim 1, further comprising:
receiving one or more performance metrics corresponding to performance of the machine learning model;
based on the one or more performance metrics, generating an updated allocation of one or more computing resources of the plurality of computing resources available for the machine learning model; and
deploying the updated allocation of one or more computing resources of the plurality of computing resources available for the machine learning model.

10. The method of claim 9, wherein the one or more performance metrics include computing resource usage metrics.

11. The method of claim 9, wherein the generating of the updated allocation of one or more computing resources of the plurality of computing resources available for the machine learning model is based on at least one performance metric of the one or more performance metrics not exceeding a threshold amount.

12. A system comprising:
a memory component; and
a processing device coupled to the memory component, the processing device to perform operations comprising:
receiving convention logic pertaining to a machine learning model and computing resource data corresponding to a plurality of computing resources available;
based on the convention logic and the computing resource data, generating a machine learning model and an allocation of one or more computing resources of the plurality of computing resources available for the machine learning model, in which the machine learning model conforms to the convention logic; and
deploying the machine learning model and the allocation of the one or more computing resources of the plurality of computing resources available for the machine learning model.

13. The system of claim 12, wherein the convention logic includes one or more computing resource efficiency rules configured to optimize usage of the plurality of computing resources available for the machine learning model.

14. The system of claim 12, wherein the convention logic includes one or more of threshold logic, auto-scaling logic, operational logic, load balancing logic, redundancy logic, data privacy logic, audit logic, cost optimization logic, energy consumption logic, real-time model adjustment logic, deployment scheduling logic, or maintenance scheduling logic.

15. The system of claim 12, further comprising receiving orchestration logic pertaining to the machine learning model, and wherein the generating of the machine learning model and the allocation of the one or more computing resources of the plurality of computing resources available is based on the orchestration logic.

16. The system of claim 12, wherein the receiving of the convention logic is via user input via a user interface of a client device.

17. The system of claim 12, further comprising:
receiving performance data corresponding to performance of the machine learning model;
based on the performance data, generating an updated allocation of one or more computing resources of the plurality of computing resources available for the machine learning model; and
deploying the updated allocation of one or more computing resources of the plurality of computing resources available for the machine learning model.

18. The system of claim 12, further comprising:
receiving updated computing resource data corresponding to the plurality of computing resources available;
based on the updated computing resource data, generating an updated allocation of one or more computing resources of the plurality of computing resources available for the machine learning model; and
deploying the updated allocation of one or more computing resources of the plurality of computing resources available for the machine learning model.

19. The system of claim 17 wherein the updated allocation of one or more computing resources of the plurality of computing resources available for the machine learning model is adapted to the updated computing resource data of the plurality of computing resources to increase efficiency of utilization of the plurality of computing resources available by the machine learning model.

20. A non-transitory computer-readable storage medium storing executable instructions, which when executed by a processing device, cause the processing device to perform operations comprising:
receiving orchestration logic and convention logic pertaining to a machine learning model and computing resource data corresponding to a plurality of computing resources available;
based on the orchestration logic, the convention logic, and the computing resource data, generating the machine learning model and an allocation of one or more computing resources of the plurality of computing resources available; and
deploying the machine learning model and the allocation of the one or more computing resources of the plurality of computing resources available for the machine learning model.
